(19) United States
(12) Patent Application Publication
(10) Pub. No.: US 2014/0284296 A1
(43) Pub. Date: Sep. 25, 2014

(54) VESSEL AND CRANE WITH FULL DYNAMIC COMPENSATION FOR VESSEL AND WAVE MOTIONS AND A CONTROL METHOD THEREOF

(71) Applicant: IHC HOLLAND IE B.V., Sliedrecht (NL)

(72) Inventors: Mark Johan Appels, Den Haag (NL); Cornelis Jacobus Van Der Harst, Driebergen-Rijsenburg (NL)

(73) Assignee: IHC Holland IE B.V., Sliedrecht (NL)

(21) Appl. No.: 14/356,295

(22) PCT Filed: Nov. 9, 2012
(86) PCT No.: PCT/NL2012/050796

§ 371 Date: May 5, 2014

(30) Foreign Application Priority Data
Nov. 9, 2011 (NL) 2007761

(51) Int. Cl. B66C 13/04; B66C 23/52; B66C 13/48

(52) U.S. Cl. CPC B66C 13/04; B66C 13/48; B66C 23/52
USPC 212/276

(57) ABSTRACT

A vessel (10) includes a crane (12) for positioning diver transfer equipment (36) and/or diver equipment (38) overboard the vessel (10) into a body of water (2). The crane (12) includes: a crane base (24) connected to the vessel (10); a crane arm (14) with a suspension point (16) that is movably connected to the crane base (24); and control elements (26) for controlling the crane arm (14) configuration. The control elements (26) are configured for: determining a change in position and/or orientation of the crane (12) resulting from vessel motion, and dynamically adjusting the crane arm configuration to change the position of the suspension point (16) with respect to the crane base (24) so as to at least partially compensate for the change in position and/or orientation of the crane (12).

### TECHNICAL FIELD

The invention relates to a vessel comprising a crane for positioning diver transfer equipment and/or diver equipment overboard the vessel into a body of water.

Furthermore, the invention relates to a crane, and to a method for positioning diver transfer equipment and/or diver equipment overboard a vessel and into a body of water, using the crane.

### BACKGROUND

The “equipment” refers herein to various objects involved in diving operations, like diver transfer equipment (e.g. a diving bell, chamber, or basket, preferably carrying diving personnel inside the transfer equipment), and diver equipment (e.g. tooling, supplies, or spare gear, optionally carried in a workbasket). According to known diver deployment methods, the diver transfer equipment and/or diver equipment is placed overboard a diving support vessel and into a body of water by either deployment over the side of the vessel hull, or by deployment through a moon pool. A small crane with a single heave arm and a winch may be used for lowering and hoisting the diver equipment into and out of the water body. The load is carried by the cable at a connection point, and is repositionable by controlling the winch and/or by vertically adjusting the heave arm. Deployment of diver transfer equipment commonly involves the use of a dedicated launch and recovery system (LARS) incorporating a winch carrying a cable for suspending the diver transfer equipment. The diver transfer equipment is thus deployed either through the moon pool or over the side of the vessel. Often, this deployment further involves a known method of cross-hauling using a small crane with a single heave arm and a winch carrying a further cable for suspending the diver transfer equipment. During cross-hauling, the submerged diver transfer equipment is horizontally transferred towards the work site, while the crane gradually takes over the suspension function from the LARS.

A disadvantage of the known methods is that the diver transfer equipment and/or diver equipment are positioned into the body of water at a relatively small projected horizontal distance away from the vessel, which in the case of diving operations in which the vessel is not able or allowed to be positioned nearby the target, results in significant swimming times required for the divers to commute between their bell and equipment, and the work site. This may be the case during diving operations for sea platform construction or Inspection Repair and Maintenance (IRM), wherein the platform's construction prohibits the vessel from approaching the platform base. The unfavourably long swimming distances incur additional costs, and form a limiting factor in planning and finding a suitable operational window in the ever changing environmental conditions. Positioning a load at a larger horizontal distance away from the vessel using a crane is difficult and dangerous, because relatively small movements of the vessel, such as heave and rotational movements like yaw, pitch and roll, will result in relatively large movements of the crane's suspension point, especially under rough environmental conditions.

Patent applications US2010/0230370 and WO2009/036456 disclose floating vessels with a crane for lifting loads, in which the crane system is provided with (vertical) heave compensation for wind and wave induced vessel motion. The disclosed heave compensation employs automatic control of the winch that carries the load line, based on to heave moment measurements. Consequently, only vertical heave motion is compensated for in the described crane systems.

Patent application GB2252295 discloses a control system for an offshore crane on a floating vessel. The disclosed system provides vessel motion compensation by automatic slew (rotational) motor control of the crane base with respect to the vessel hull. As a result, the disclosed system helps reducing swinging motion of the load suspended above the water surface.

### SUMMARY

It is an object to provide a device and method for positioning and suspending diver transfer equipment and/or diver equipment overboard a floating vessel and into a body of water, with increased accuracy and safety, in particular under rough environmental conditions.

Therefore, according to a first aspect, there is provided a vessel comprising a crane for positioning diver transfer equipment and/or diver equipment overboard the vessel into a body of water, whereby the crane comprises: —a crane base that is connected to the vessel; —a crane arm with a suspension point that is movably connected to the crane base; —control means for controlling the crane arm configuration to place the suspension point at a position with respect to the crane base or to control the suspension point (16) to follow a predetermined path; whereby the control means are configured for:

—determining a change in position and/or orientation of the crane resulting from vessel motion, and —dynamically adjusting the crane arm configuration to change the position of the suspension point with respect to the crane base so as to at least partially compensate for the change in position and/or orientation of the crane.

The described vessel allows for positioning a diving chamber (possibly carrying diver personnel) and/or equipment overboard the vessel in a safe and accurate way, for example by cross-hauling, even when the vessel moves up and down due to waves (heave) and in case of vessel orientation changes such as yaw, pitch and roll movements. The control means may be arranged to compensate for lateral movements of the vessel (sway and surge), although such movements may also be compensated by a known dynamic positioning system present on the vessel. Such a vessel could be used to position the load to an underwater position and keeping it relatively steady despite movements of the vessel. This makes it for instance possible for divers to work while the diver transfer equipment and diver operational equipment is being held nearby and readily accessible in a steady position by the crane. The crane arm may comprise a number of actuators to move the crane arm and to thereby position the suspension point at a desired position. The configuration of the crane may be three-dimensionally adjustable, based on a change in a position or orientation of the crane, and by cooperation of one or several of the motion compensation systems described below, in such a way that objects suspended from the crane (e.g. diving transfer equipment) are kept at least partially steady irrespective of environmental influences. The term “position” is herein identified with a set of location parameters (e.g. x-y-z), and distinguished from the term “orientation”, which refers to a set of rotational parameters (e.g. pitch-yaw-roll). If it is required to deploy the load at a significant horizontal distance away from the vessel hull, then without further measures, the deflection of the load attached at or near the suspension point of the crane would be greatly enhanced by environmentally induced vessel motion, the enhancement being attributable to the lever effect on the free end of the crane arm. By dynamically adjusting the crane configuration and in response to a change in position of the vessel (i.e. the crane base), the suspension point can be kept at least partially steady. Thus, swinging of the load carried at the suspension point and above the water line due to sudden vessel movements is compensated for. Also, wave forces acting on the load while traversing the splash-zone may be reduced by actively adapting the crane tip motion parallel to the wave motion.

Determining a change in position and/or orientation of the crane resulting from vessel motion may be done in any suitable way. This may for instance be done using sensors sensing motion and/or position and/or orientation of the vessel. The sensors may also comprise one or more floating buoys in the vicinity of the vessel, the floating buoys comprising sensors, such as motion, position and orientation sensors, for measuring wave motions and to predict vessel motion as a result of wave motion.

Determining a change in position and/or orientation of the crane may also include taking into account deformation of the vessel, in particular the hull of the vessel. This is in particular important in cases where the sensors used for determining change in position and/or orientation of the crane are positioned on a location on the vessel remote from the crane. The control means may be arranged to run software capable of computing deformation of the vessel.

Determining a change in position and/or orientation of the crane resulting from vessel motion may also be done using such sensors in combination with prediction software which predicts vessel motion and possibly vessel deformation in the near future (for instance 3 seconds ahead). This allows to dynamically adjust the crane arm configuration even more accurately.

According to an embodiment the vessel (10) comprises a winch (17) with a rope (30), the winch (17) being positioned on a fixed position with respect to the crane base (24) and the rope (30) running from the winch (17) to the suspension point (16) with a free rope end hanging from the suspension point (16), wherein the control means (26) are configured for controlling the winch (17) to give out or take in rope (30) to compensate for the dynamic adjustment of the crane arm configuration. This may be done in order to keep a length of the free rope end constant or to ensure that the payload follows a predetermined path.

The winch is for instance positioned on the crane base or on deck of the vessel. The rope is at least partially wound around a winch axis of the winch such that the winch can give out or take in rope by rotating the winch axis.

By adjusting the crane arm configuration to change the position of the suspension point with respect to the crane base, the length of the free end of the rope may change. This is undesirable as it results in an up or downward movement of the load connected to the rope (diver transfer equipment and/or diver equipment), which could result in dangerous situations for divers at work and may cause seasickness of divers. So, by controlling the winch to give out or take in rope this can be compensated. Controlling the winch may be done dynamically and may be done simultaneously with the dynamic adjustment the crane arm configuration.

According to an embodiment, the crane arm comprises a plurality of interconnected arm segments, the control means being configured for controlling relative orientations of the arm segments in response to the determined change in position and/or orientation of the crane.

A crane arm having two or more interconnected arm segments that are repositionable with respect to each other and the crane base (which requires at least two movable interconnections) has sufficient motional degrees of freedom to provide on its own all vessel/crane motion compensation capacity required for keeping the suspension point steady. The arm segments may be interconnected by for example hingeable, telescoping, and/or axially rotatable arm joints. The crane may comprise actuators, such as hydraulic actuators, which can move the different arm segments with respect to each other and keep the arm segments in desired relative orientations. Controlling the relative orientation of the arm segments may be advantageous to compensate for lateral movements of a vessel (sway and surge) in a direction parallel to the horizontal direction of the crane arm.

According to an embodiment, the crane arm is movably attached to the crane base with hydraulic repositioning means controllable by the control means for adjusting a pitch-and-roll configuration of the crane arm in response to the determined change in position and/or orientation of the crane.

Advantageously, the hydraulic repositioning means enables dynamic compensation of the crane configuration with respect to pitch and/or roll changes in the orientation of the vessel (and consequently in the orientation of the fixed crane base). Consequently, suspension point adjustment is enabled in response to wave induced vessel motion.

According to an embodiment, the crane arm comprises a telescoping arm portion, the control means being configured for controlling the extension and/or retraction of the telescoping arm portion, thereby adjusting a projected arm length in response to the determined change in position and/or orientation of the vessel or crane base. The crane may comprise actuators, such as hydraulic actuators, which can extend or retract the telescoping arm portion or arm segments. Controlling such extendable and retractable arm segments may be advantageous to compensate for lateral movements of a vessel (sway and surge) in a direction parallel to the horizontal direction of the crane arm, but also for compensation of lateral movements of the crane tip resulting from a rolling motion of the vessel.

According to a further embodiment, the crane arm is rotatably connected to the crane base, the control means being configured for rotating the crane arm with respect to the crane base in response to the determined change in position and/or orientation of the vessel or crane base.

According to yet a further embodiment, the crane arm is rotatable about a vertical rotation axis.

Rotating the crane arm with respect to the crane base about a vertical rotational axis may be advantageous to compensate for a rotational change of orientation of the vessel about a vertical axis (yaw), or for compensation of lateral movements of the crane tip resulting from pitching of the vessel.

According to another further embodiment, the crane arm is rotatable about at least two horizontal rotation axes.

Rotating the crane arm about two or more horizontal rotational axes may be advantageous to compensate for pitch-and-roll movements of the vessel, while holding the suspension point at a fixed projected horizontal distance from the vessel hull.

According to an embodiment, the vessel comprises a crane kinematics sensor for determining the change in position and/or orientation of the crane.

As already indicated, this may include prediction the change in position and/or orientation and may include computing (predicted) deformation of the vessel.

The crane kinematic sensor may for instance be mounted on the crane, such as on the base or on/close to the suspension point to directly measure changes in position and/or orientation of the crane. The kinematic sensor may be formed as part of the control means, and may comprise one or more of an acceleration sensor, a gyroscope and a global positioning system. According to a further embodiment, the crane kinematics sensor is positioned on or close to the suspension point. By providing the kinematic sensor on or close to the suspension point of the crane, feedback can be obtained about the dynamic compensation and corrections may be made to further improve the dynamic compensation.

According to an embodiment, the vessel comprises a vessel kinematics sensor for determining a change in position and/or orientation of the vessel, whereby the control means are configured for dynamically adjusting the crane arm configuration to change the position of the suspension point based on the determined change in position and/or orientation of the vessel.

The vessel kinematics sensor may be provided alternatively or in addition to the crane kinematics sensor described herein above. Furthermore, the vessel kinematics sensor may be formed as part of the crane control means, and may also comprise one or more of an acceleration sensor, a gyroscope and a global positioning system. Alternatively, the vessel kinematics sensor may be already installed on the vessel as part of the vessel positioning and motion reference system, e.g. navigation control or dynamic positioning (DP) system. If the DP-system is active, the planar motion of the vessel can be already (at least partially) compensated for by the DP thrusters, and the crane arm configuration need only be dynamically adjusted to compensate for the remaining vessel motion components. The vessel motion data measured by the vessel kinematics sensor may in any case be used as input for the crane control means.

According to yet a further embodiment, the control means are configured for determining a change in height of the crane due to a heave movement of the vessel, and for controlling the crane arm to change the height of the suspension point with respect to the base in an opposite direction.

Such an embodiment has the advantages that the load is not constantly moving up and down with the vessel, which could cause damage, especially when the diving bell or equipment is closely above the water surface above a rising wave while the vessel performs a downward movement. Controlled height adjustment of the crane suspension point may be supplemented by control of the winch in order to increase or reduce hoisting wire length.

According to another further embodiment, the control means are configured for determining a change in orientation of the crane due to a rotational movement of the vessel, and for controlling the crane arm to change the orientation of the suspension point with respect to the base to compensate for the determined change in orientation.

Often, the crane is attached to the vessel near an edge of the deck, and not in the vessel's centre of rotational motion. Consequently, the position of the entire crane will change during rotational (i.e. pitch-roll-yaw) movement of the vessel. This embodiment has the advantage that the diver personnel and or diver equipment is not subjected to relatively large swaying motions resulting from wave induced vessel rotation, which could cause seasickness or damage. Furthermore, impact with the water surface is, especially when the diver personnel or diver equipment is closely above the water surface and hits the water surface with great force because of the swaying motions.

According to an embodiment, the control means (26) are configured for determining a deformation of the vessel and the dynamically adjustment of the crane arm configuration takes into account a determined deformation of the vessel.

According to a second aspect, and in accordance with the advantages and effects described herein above, a crane is provided for positioning and suspending diver transfer equipment and/or diver equipment overboard a vessel into a body of water, whereby the crane comprises: —a crane base, a moveable crane arm and a suspension point, —control means for controlling the crane arm to position the suspension point at a relative position with respect to the crane base or to control the suspension point (16) to follow a predetermined path, characterized in that the control means are configured for: —determining a change in position and/or orientation of the crane base, and —dynamically adjusting the crane configuration to change the position of the suspension point with respect to the crane base so as to at least partially compensate for the change in position and/or orientation of the crane base.

The crane base may be configured for mounting to the deck of a floating vessel.

According to an embodiment the crane (12) comprises a winch (17) with a rope (30), the winch (17) being fixedly connected the crane base (24) and the rope (30) running from the winch (17) to the suspension point (16) with a free rope end hanging from the suspension point (16), wherein the control means (26) are configured for controlling the winch (17) to give out or take in rope (30) to compensate for the dynamic adjustment of the crane arm configuration in order to keep a length of the free rope end constant.

According to a third aspect, and in accordance with the advantages and effects described herein above, a method is provided for positioning and suspending diver transfer equipment and/or diver equipment overboard a vessel and into a body of water, using a crane positioned on the vessel, the crane comprising a crane base, a moveable crane arm and a suspension point, the method comprising: a) controlling the crane arm to position the suspension point at a relative position with respect to the crane base or to control the suspension point (16) to follow a predetermined path; b) determining a change in position and/or orientation of the crane resulting from the vessel motion, and c) dynamically adjusting the crane configuration to change the position of the suspension point with respect to the crane base so as to at least partially compensate for the change in position and/or orientation of the crane.

According to an embodiment the vessel (10) comprises a winch (17) with a rope (30), the winch (17) being positioned on a fixed position with respect to the crane base (24) and the rope (30) running from the winch (17) to the suspension point (16) with a free rope end hanging from the suspension point (16), wherein method comprises d) dynamically controlling the winch (17) to give out or take in rope (30) to compensate for the dynamic adjustment of the crane arm configuration in order to keep a length of the free rope end constant.

Actions c) and d) may be performed in parallel.

Actions b) may performed in any suitable way, for instance as described above, and my thus included using sensors sensing motion and/or position and/or orientation of the vessel, taking into account deformation of the vessel, predicting vessel motion and possibly vessel deformation.

According to an embodiment, the method comprises: —determining a local vertical motion of the body of water with respect to the vessel, and —dynamically adjusting the crane arm configuration to change the position of the suspension point with respect to the crane base so as to at least partially compensate for the local vertical motion of the body of water.

The local vertical motion of the body of water refers to local wave motion at or near the location of the water surface coinciding with the vertical projection of the suspension point. Such wave motion may for example be measured by a floating buoy with a vertical position detector, from which local wave motion measurement data is received by the crane control means and used as input for the dynamic crane arm configuration adjustment. Advantageously, by compensating for the local wave motion, the impact of the suspended diver equipment upon traversing the water surface into the water body (i.e. the “splash-zone”) will be significantly diminished.

According to an embodiment, the method comprises: —determining a target position or target path of the suspension point, wherein action a) comprises positioning the suspension point at the target position or target path, wherein action b) comprises determining a current position of the suspension point and determining a change in position of the suspension point. The target position is defined with respect to an earth (global) coordinate system.

According to another embodiment, the method comprises: using distinct cranes for separately positioning each of the diver transfer equipment and the diver equipment overboard the vessel and into the body of water, whereby the respective cranes are positioned on the vessel, and comprise respective crane bases, respective moveable crane arms and respective suspension points, the method comprising: —controlling the respective crane arms to position the respective suspension points at relative positions or relate paths with respect to the respective crane bases; —determining changes in positions and/or orientations of the respective cranes; —dynamically controlling the respective crane arms to change the relative positions of the respective suspension points with respect to the respective crane bases to at least partially compensate for the determined changes in positions and/or orientations of the respective crane bases; —keeping the respective suspension points at least partially steady with respect to each other.

According to an embodiment, the method comprises:

—using distinct cranes (12) for positioning a single payload, such as diver transfer equipment (36) or diver equipment (38), overboard the vessel (10) and into the body of water (2), whereby the respective cranes (12) are positioned on the vessel (10), and comprise respective crane bases (24), respective moveable crane arms (14) and respective suspension points (16), the method comprising:
—controlling the respective crane arms (14) to position the respective suspension points (16) at relative positions or relate paths with respect to the respective crane bases (24);
—determining changes in positions and/or orientations of the respective cranes (12);
—dynamically controlling the respective crane arms (14) to change the relative positions of the respective suspension points (16) with respect to the respective crane bases (24) to at least partially compensate for the determined changes in positions and/or orientations of the respective crane bases (24);
—controlling the distinct cranes to keep the payload at a desired position or at a desired path.

The controlling of the distinct cranes may be done by central control means. The central control means determine (e.g. compute) a desired position, orientation and/or path of the payload with respect to the vessel. Next, actions b) and c) as described above are performed. The position of the distinct cranes is measured at the cranes and send to the central control means as feedback. The central controller may compute a total error based on the feedback and send instructions to the cranes to correct for this total error.

Advantageously, the diver transfer equipment and diver equipment can be freely suspended in the body of water by means of the pair of dynamically compensated cranes, and kept relatively steady with respect to the (earth fixed) operational target as well as each other.

According to an embodiment the distinct cranes each have an associated winch (17) with a rope (30), the winches (17) being positioned on fixed positions with respect to the crane bases (24) and the respective ropes (30) running from the respective winches (17) to the respective suspension points (16) with free rope ends hanging from the respective suspension points (16), wherein method comprises

d) dynamically controlling the respective winches (17) to give out or take in rope (30) to compensate for the dynamic adjustment of the respective crane arm configurations. This may be done in order to keep the respective lengths of the free rope ends constant.

In case two cranes are used to carry a single payload, controlling the winches is done in cooperation to ensure that the position of the payload doesn't change with respect to the suspension points. As the payload may be positioned somewhere in between the cranes, the free rope end may have a non-vertical orientation which needs to be taken into account when dynamically controlling the winches.

According to an embodiment, the method comprises: —suspending the diver transfer equipment and/or diver equipment in the body of water below a water surface while dynamically adjusting the crane arm configuration to change the position of the suspension point with respect to the crane base so as to at least partially compensate for the change in position and/or orientation of the crane resulting from vessel motion. The proposed method is thus employed during diving operations, with the result of keeping the diver and tool deployment location steady for the divers and close to the target.

### BRIEF DESCRIPTION OF THE DRAWINGS

Embodiments will now be described, by way of example only, with reference to the accompanying schematic drawings in which corresponding reference symbols indicate corresponding parts, and in which:

FIG. 1 schematically shows a schematic rear view of a diving support vessel according to an embodiment;

FIGS. 2 and 3 schematically shows a schematic view of a vessel according to alternative embodiments.

The figures are meant for illustrative purposes only, and do not serve as restriction of the scope or the protection as laid down by the claims.

### DETAILED DESCRIPTION

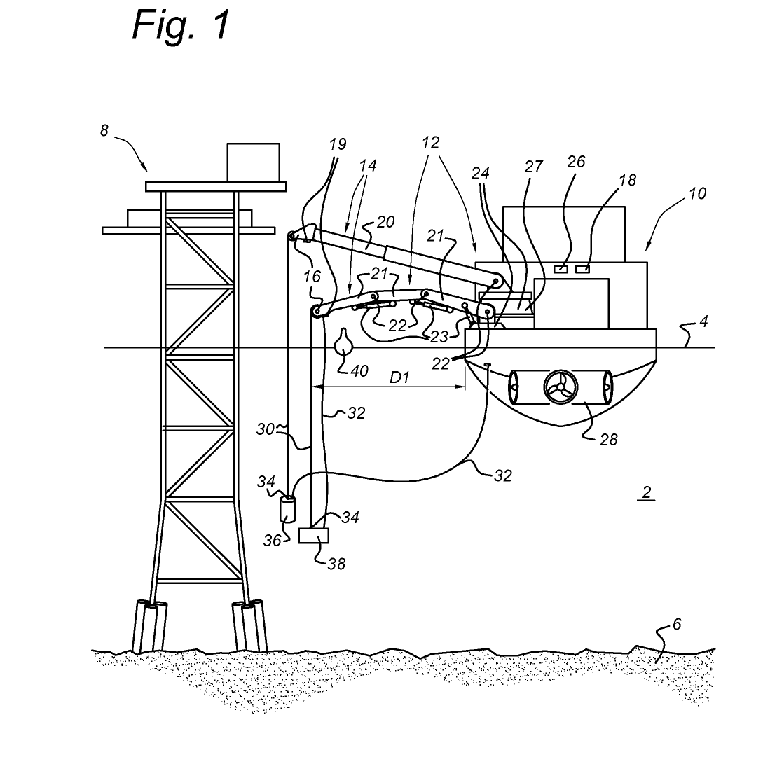

FIG. 1 schematically shows a rear view of a diving support vessel 10 that is floating in a body of seawater 2 bounded from above by a water surface 4 and from below by a seabed 6. The vessel 10 is floating in the proximity of a platform 8 that is supported by the seabed 6, the vessel 10 being located at a sufficient distance for avoiding accidental collision with a support structure of the platform 8. The vessel 10 as shown in FIG. 1 has two cranes 12, one of which is used for positioning diver transfer equipment 36 (here, a diver bell) and the other for positioning diver equipment 38 (here, a repair tool basket or working basket) overboard the vessel 10 into the water body 2. Each crane 12 comprises a crane base 24 that is connected to the vessel 10 at a top side of its hull. Each crane 12 further comprises a crane arm 14 with a load suspension point 16 at a remote end of the crane arm 14. Each suspension point 16 carries a cable 30 that is attached at a connection point 34 to a load, in this case the diver bell 36 or diver equipment 38. By moving the crane 12 and changing a length of the cable 30, the load 36, 38 can be hoisted into and out of the water body 2. The diver bell 36 and/or diver equipment 38 are supplied with required resources (e.g. power, communication, etc) through an umbilical 32 connected to resource units on the vessel 10.

The crane arms 14 are rotatably connected to respective crane bases 24. A first one of the crane arms 14 comprises a plurality of hingably interconnected arm segments 21, which are mutually repositionable by linear arm actuators or pistons 23, allowing the crane 12 to be vertically raised and lowered and horizontally extended and retracted. A typical length for the arm segments 21 for a crane 12 used for the purpose described herein is 5-15 metres, resulting in a typical horizontal projected hoisting distance D1 of 10 to 30 meters away from the vessel hull.

The second crane arm 14 has a telescoping arm portion 20, which is extendable and retractable with respect to an arm segment 21 that is hingably connected to its crane base 24. Furthermore, the second crane arm 14 is at a lower end of the arm segment 21 movably attached to the crane base 24 by means of hydraulic repositioning means 27. Both crane arms 14 are rotatably connected to their crane bases 24 about vertical rotation axes. Rotatability about horizontal rotation axes is also provided for each crane arm 14 by means of the arm joints 22.

The vessel 10 has a known dynamic positioning system 28 including a vessel kinematics sensor 18 for determining a change in position and/or orientation of the vessel 10. Alternatively or in addition, each crane arm 14 has near its suspension point 16 a crane kinematics sensor 19 for determining the change in position and/or orientation of the crane 12 at the suspension point 16.

Control means 26 are provided for controlling the configuration of each crane arm 14 to move the corresponding suspension point 16 to a desired position with respect to the crane base 24. The control means 26 are configured for determining a change in position and/or orientation of the crane suspension point 16 resulting from vessel motion. This change in position of the suspension point 16 is determined from measurements by vessel kinematics sensor 18 and/or the crane kinematics sensor 19. The position of the crane base 24 may for instance be derived from positional measurement data for the vessel 10, which are collected by the vessel kinematics sensor 18.

The crane configuration control means 26 control the dynamic adjustment of the configurations of both crane arms 14 to change the positions of the respective suspension points 16 with respect to their crane bases 24, so as to at least partially compensate for the change in position and/or orientation of the cranes 12 as measured by the crane kinematics sensors 19, and supplemented or substituted by the change in position and/or orientation of the vessel 10 as measured by the vessel kinematics sensor 18. The control means 26 is configured for rotating each of the crane arms 14 with respect to the crane bases 24 in response to the determined change in position and/or orientation of the crane 12 or vessel 10. The control means 26 is thus arranged to receive measurement data from the kinematics sensors 18, 19, process this information to compute a change in position of the suspension points 16 and control the actuators 23 to compensate for this change.

The control means 26 is configured for dynamically adjusting the relative orientations of the arm segments 21 and arm joints 22 for the first crane 12, in response to the determined changes in position and/or orientation, by controlling the arm actuators 23. Furthermore, the control means 26 is configured for controlling the extension and retraction of the telescoping arm portion 20 for the second crane 12, thereby adjusting a projected arm length in response to the determined change in position and/or orientation of the crane 12 or vessel 10.

A wave measurement system may be installed, for instance formed by a floating buoy 40 which is located in the water body 2 at or near a location in which the suspension cables 30 intersect the water surface 4. The buoy 40 is provided with a sensor configured for measuring a local vertical wave motion with respect to the vessel 10. Measurement data of the local water level executed by the buoy 40 sensor is transmitted to and interpreted by the crane configuration control unit 26, which data is utilised for adjusting the configurations of the crane arms 14 to change the positions of the suspension points 16 with respect to the respective crane bases 24 so as to at least partially compensate for the local vertical motion of the body of water 2.

The diver bell 36 and equipment 38 are preferably deployed at a significant horizontal distance D1 away from the vessel hull, a significant distance herein corresponding with a range of 5 to 50 meters, and preferably 10 to 20 meters. Without further measures, the deflection of the loads 36, 38 attached at or near the suspension points 16 would be greatly enhanced by environmentally induced vessel motion, the enhancement being attributable to the lever effect on the free end of the crane arms 14. By dynamically adjusting the configurations of the crane arms 14 in at least two dimensions, and in response to a change in position and/or orientation of the vessel 10 or the crane 12, the suspension points 16 are kept at least partially steady. Thus, swinging of the bell 36 and equipment 38 hoisted at the suspension points 16 and above the water surface 4 due to (sudden) vessel movements is compensated for.

So, the control means 26 may be arranged to receive measurement data from the kinematics sensors 18, 19 and the wave measurement system 40, process this information to control the actuators 23 to compensate for wave motions to reduce the impact of the positioning diver transfer equipment 36 (e.g. diving bell) and/or diver equipment 38 when hitting the water surface 4 and after having passed the water surface 4, receive measurement data from the kinematics sensors 18, 19, process this information to compute a change in position of the suspension points 16 and control the actuators 23 to compensate for this change. Once the water surface has been passed, the waves will no longer be able to hit the diver transfer equipment 36 (e.g. diving bell) and/or diver equipment 38. Of course, the wave measurement system 40 may cooperate with the vessel kinematics sensor 18 to predict vessel motion.

According to embodiments, there is provided a method for positioning diver transfer equipment 36 (e.g. diving bell) and/or diver equipment 38 overboard a side of a vessel 10 and into a body of water 2, using a crane 12 that is movably connected to the vessel 10 as described herein above. The method comprises: controlling the crane arm 14 to place the suspension point 16 at a relative position with respect to the crane base 24; determining a change in position and/or orientation of the crane 12 resulting from vessel motion, and dynamically adjusting the crane arm configuration to change the position of the suspension point 16 with respect to the crane 12 so as to at least partially compensate for the change in position and/or orientation of the crane 14 resulting from vessel motion.

The method may involve hoisting the bell 36 and/or diver equipment 38 from the suspension point 16 at a projected horizontal distance D1 from the vessel 10, while the configuration of the crane arm 14 is dynamically adjusted in three dimensions to at least partially compensate for the change in position and/or orientation of the crane 12 (or the vessel 10), so as to keep the suspension point 16 at least partially steady.

According to the embodiments, the configuration of the crane 12 is (three-dimensionally) adjusted based on a determined change of the vessel position and/or orientation, and by cooperation of some or all of the various motion compensation systems described herein above, in such a way that objects suspended from the crane 12 (e.g. diving bells 36, diver baskets, or equipment 38) are kept at least partially steady irrespective of environmental influences. The position and/or orientation of the vessel 10 refer to its position and/or orientation with respect to an earth fixed (global) coordinate system. The suspension point 16 is kept steady with respect to the same earth fixed coordinate system.

The diver transfer equipment 36 and diver equipment 38 can be suspended in the body of water 2 below the water surface 4, while the configurations of both crane arms 14 are jointly dynamically adjusted so as to change the positions of the respective suspension points 16 with respect to their crane bases 24.

A buoy 40 with water motion sensor may be used in the method for determining a local vertical motion of the water body 2 and with respect to the vessel 10 at or near the location in which the suspension cables 30 intersect the water surface 4. Based on measurement data of the local vertical wave motion, the configurations of the crane arms 14 are dynamically adjusted to change the position of the suspension points 16 with respect to the crane base 24 so as to at least partially compensate for the local vertical motion of the body of water 2.

According to a further embodiment a method is provided for positioning diver transfer equipment 36 and/or diver equipment 38 overboard a vessel 10 and into a body of water 2, using a crane 12 positioned on the vessel 10, the crane 12 comprising a crane base 24, a moveable crane arm 14 and a suspension point 16, the method comprising:

—determining a local vertical motion of the body of water 2 with respect to the vessel 10, and
—dynamically adjusting the crane arm configuration to change the position of the suspension point 16 with respect to the crane base 24 so as to at least partially compensate for the local vertical motion of the body of water 2 when transferring the diver transfer equipment 36 and/or diver equipment 38 through the water surface 4.

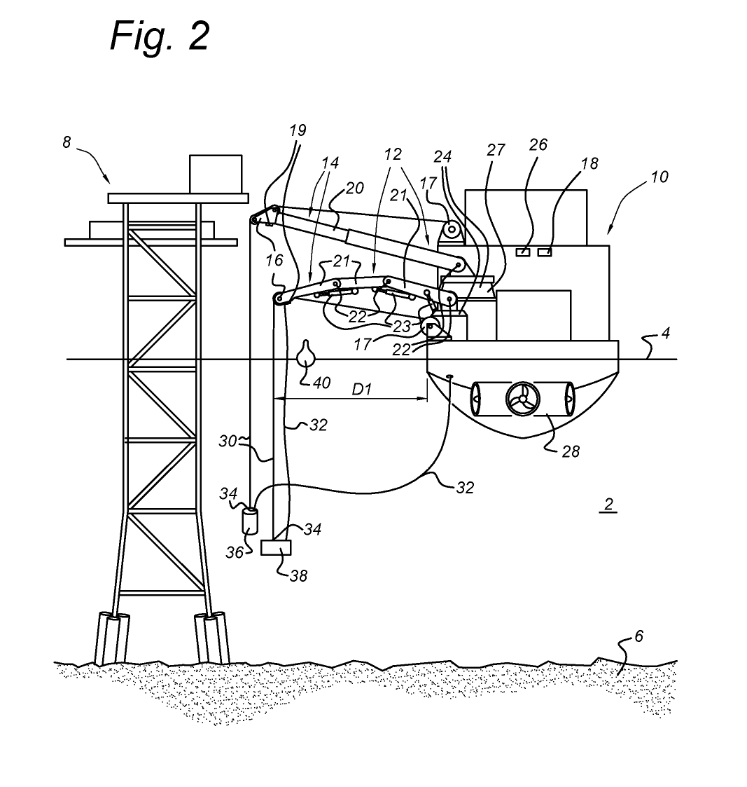

FIG. 2 shows a vessel similar to FIG. 1, now also showing winches 17 positioned on the vessel 10, for instance on a deck of the vessel 10. The winch 17 comprise rope and are arranged to give out and take in rope under control of control means, such as the control means 26 described above.

When the position of the suspension point is dynamically adjusted to take into account vessel motion and/or vessel deformation, the distance between the suspension point 16 and the winch 17 may change, resulting in a change of the length of the free end of the rope 30 and thus in an undesired change in position of the payload. In order to compensate for this, the control means 26 are configured for dynamically controlling the winch 17 to give out or take in rope 30 to compensate for the dynamic adjustment of the crane arm configuration. Controlling the winch may be done dynamically and may be done simultaneously with the dynamic adjustment the crane arm configuration.

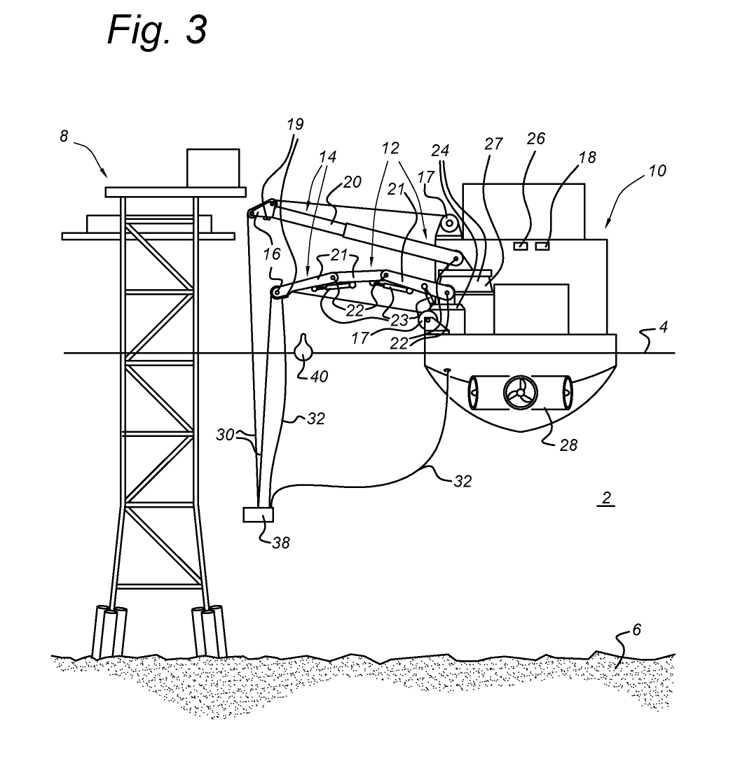

FIG. 3 shows an alternative embodiment, in which a single payload is suspended from distinct cranes 12 comprising a control means 26 arranged to

—control the respective crane arms (14) to position the respective suspension points (16) at relative positions or relate paths with respect to the respective crane bases (24);
—determine changes in positions and/or orientations of the respective cranes (12);
—dynamically control the respective crane arms (14) to change the relative positions of the respective suspension points (16) with respect to the respective crane bases (24) to at least partially compensate for the determined changes in positions and/or orientations of the respective crane bases (24);
—control the distinct cranes to keep the payload at a desired position or at a desired path.

Controlling the distinct cranes may be done in cooperation to control the position and orientation of the single payload. Also, dynamical control of the winches 17 to give out or take in rope (30) to compensate for the dynamic adjustment of the respective crane arm configurations may also be done in cooperation.

The descriptions above are intended to be illustrative, not limiting. It will be apparent to the person skilled in the art that alternative and equivalent embodiments of the invention can be conceived and reduced to practice, without departing from the scope of the claims set out below.

### LIST OF FIGURE ELEMENTS

2 water body
4 water surface
6 seabed
8 platform
10 vessel
12 crane
14 crane arm
16 suspension point
18 vessel kinematics sensor
19 crane kinematics sensor
20 telescoping arm portion
21 arm segment
22 arm joint
23 arm actuator
24 crane base
26 control means
27 hydraulic repositioning means
28 dynamic positioning system
30 cable
32 umbilical and guide wires
34 connection point
36 diver transfer equipment
38 diver equipment
40 measurement buoy
D1 projected horizontal distance

1. Vessel (10) comprising a crane (12) for positioning diver transfer equipment (36) and/or diver equipment (38) overboard the vessel (10) into a body of water (2), whereby the crane (12) comprises:
a crane base (24) that is connected to the vessel (10);
a crane arm (14) with a suspension point (16) that is movably connected to the crane base (24);
control means (26) for controlling the crane arm (14) configuration to place the suspension point (16) at a position with respect to the crane base (24) or to control the suspension point (16) to follow a predetermined path;
whereby the control means (26) are configured for:
determining a change in position and/or orientation of the crane (12) resulting from vessel motion, and
dynamically adjusting the crane arm configuration to change the position of the suspension point (16) with respect to the crane base (24) so as to at least partially compensate for the change in position and/or orientation of the crane (12).

2. Vessel (10) according to claim 1, wherein the vessel (10) comprises a winch (17) with a rope (30), the winch (17) being positioned on a fixed position with respect to the crane base (24) and the rope (30) running from the winch (17) to the suspension point (16) with a free rope end hanging from the suspension point (16), wherein the control means (26) are configured for controlling the winch (17) to give out or take in rope (30) to compensate for the dynamic adjustment of the crane arm configuration.

3. Vessel (10) according to claim 1, wherein the crane arm (14) comprises a plurality of interconnected arm segments (21), the control means (26) being configured for controlling relative orientations of the arm segments (21) in response to the determined change in position and/or orientation of the crane (12).

4. Vessel (10) according to claim 1, whereby the crane arm (14) is movably attached to the crane base (24) with hydraulic repositioning means (27) controllable by the control means (26) for adjusting a pitch-and-roll configuration of the crane arm (14) in response to the determined change in position and/or orientation of the crane (12).

5. Vessel (10) according to claim 1, whereby the crane arm (14) comprises a telescoping arm portion (20), the control means (26) being configured for controlling the extension and/or retraction of the telescoping arm portion (20), thereby adjusting a projected arm length in response to the determined change in position and/or orientation of the crane (12).

6. Vessel (10) according to claim 1, whereby the crane arm (14) is rotatably connected to the crane base (24), the control means (26) being configured for rotating the crane arm (14) with respect to the crane base (24) in response to the determined change in position and/or orientation of the crane (12).

7. Vessel (10) according to claim 6, wherein the crane arm (14) is rotatable about a vertical rotation axis.

8. Vessel (10) according to claim 6, wherein the crane arm (14) is rotatable about at least two horizontal rotation axes.

9. Vessel (10) according to claim 1, comprising a crane kinematics sensor (19) for determining the change in position and/or orientation of the crane (12).

10. Vessel (10) according to claim 1, comprising a vessel kinematics sensor (18) for determining a change in position and/or orientation of the vessel (10), whereby the control means (26) are configured for dynamically adjusting the crane arm configuration to change the position of the suspension point (16) based on the determined change in position and/or orientation of the vessel (10).

11. Vessel (10) according to claim 9, wherein the control means (26) are configured for determining a change in height of the crane (12) due to a heave movement of the vessel, and for adjusting the crane arm configuration to change the height of the suspension point (16) with respect to the crane base (24) in an opposite direction.

12. Vessel (10) according to claim 9, wherein the control means (26) are configured for determining a change in orientation of the crane (12) due to a rotational movement of the vessel, and for adjusting the crane arm configuration to change the orientation of the suspension point (16) with respect to the crane base (24) to compensate for the determined change in orientation.

13. Vessel (10) according to claim 1, wherein the control means (26) are configured for determining a deformation of the vessel and the dynamically adjustment of the crane arm configuration takes into account a determined deformation of the vessel.

14. Crane (12) for positioning diver transfer equipment (36) and/or diver equipment (38) overboard a vessel (10) into a body of water (2), whereby the crane (12) comprises
a crane base (24), a moveable crane arm (14) and a suspension point (16),
control means (26) for controlling the crane arm (14) to position the suspension point (16) at a relative position with respect to the crane base (24) or to control the suspension point (16) to follow a predetermined path, whereby the control means (26) are configured for:
determining a change in position and/or orientation of the crane (14) resulting from vessel motion, and
dynamically adjusting the crane arm (14) configuration to change the position of the suspension point (16) with respect to the crane base (24) so as to at least partially compensate for the change in position and/or orientation of the crane (14).

15. Crane (12) according to claim 14, wherein the crane (12) comprises a winch (17) with a rope (30), the winch (17) being fixedly connected the crane base (24) and the rope (30) running from the winch (17) to the suspension point (16) with a free rope end hanging from the suspension point (16), wherein the control means (26) are configured for controlling the winch (17) to give out or take in rope (30) to compensate for the dynamic adjustment of the crane arm configuration in order to keep a length of the free rope end constant.

16. Method for positioning diver transfer equipment (36) and/or diver equipment (38) overboard a vessel (10) and into a body of water (2), using a crane (12) positioned on the vessel (10), the crane (12) comprising a crane base (24), a moveable crane arm (14) and a suspension point (16), the method comprising:
a) controlling the crane arm (14) to place the suspension point (16) at a relative position with respect to the crane base (24) or to control the suspension point (16) to follow a predetermined path;
b) determining a change in position and/or orientation of the crane (14) resulting from vessel motion, and
c) dynamically adjusting the crane arm configuration to change the position of the suspension point (16) with respect to the crane base (24) so as to at least partially compensate for the change in position and/or orientation of the crane (14).

17. Method according to claim 16, wherein the vessel (10) comprises a winch (17) with a rope (30), the winch (17) being positioned on a fixed position with respect to the crane base (24) and the rope (30) running from the winch (17) to the suspension point (16) with a free rope end hanging from the suspension point (16), wherein method comprises
d) dynamically controlling the winch (17) to give out or take in rope (30) to compensate for the dynamic adjustment of the crane arm configuration in order to keep a length of the free rope end constant.

18. Method according to claim 16, comprising:
determining a local vertical motion of the body of water (2) with respect to the vessel (10), and
dynamically adjusting the crane arm configuration to change the position of the suspension point (16) with respect to the crane base (24) so as to at least partially compensate for the local vertical motion of the body of water (2).

19. Method according to claim 16, comprising:
determining a target position or target path of the suspension point (16), wherein action a) comprises positioning the suspension point (16) at the target position or target position, wherein action b) comprises determining a current position of the suspension point (16) and determining a change in position of the suspension point (16).

20. Method according to claim 16, comprising:
using distinct cranes (12) for separately positioning each of the diver transfer equipment (36) and the diver equipment (38) overboard the vessel (10) and into the body of water (2), whereby the respective cranes (12) are positioned on the vessel (10), and comprise respective crane bases (24), respective moveable crane arms (14) and respective suspension points (16), the method comprising:
controlling the respective crane arms (14) to position the respective suspension points (16) at relative positions or relate paths with respect to the respective crane bases (24);
determining changes in positions and/or orientations of the respective cranes (12);
dynamically controlling the respective crane arms (14) to change the relative positions of the respective suspension points (16) with respect to the respective crane bases (24) to at least partially compensate for the determined changes in positions and/or orientations of the respective crane bases (24);
keeping the respective suspension points (16) at least partially steady with respect to each other.

21. Method according to claim 16, comprising:
using distinct cranes (12) for positioning a single payload, such as diver transfer equipment (36) or diver equipment (38), overboard the vessel (10) and into the body of water (2), whereby the respective cranes (12) are positioned on the vessel (10), and comprise respective crane bases (24), respective moveable crane arms (14) and respective suspension points (16), the method comprising:
controlling the respective crane arms (14) to position the respective suspension points (16) at relative positions or relate paths with respect to the respective crane bases (24);
determining changes in positions and/or orientations of the respective cranes (12);
dynamically controlling the respective crane arms (14) to change the relative positions of the respective suspension points (16) with respect to the respective crane bases (24) to at least partially compensate for the determined changes in positions and/or orientations of the respective crane bases (24);
controlling the distinct cranes to keep the payload at a desired position or at a desired path.

22. Method according to claim 20, wherein the distinct cranes each have an associated winch (17) with a rope (30), the winches (17) being positioned on fixed positions with respect to the crane bases (24) and the respective ropes (30) running from the respective winches (17) to the respective suspension points (16) with free rope ends hanging from the respective suspension points (16), wherein method comprises
d) dynamically controlling the respective winches (17) to give out or take in rope (30) to compensate for the dynamic adjustment of the respective crane arm configurations.

23. Method according to claim 16, comprising:
suspending the diver transfer equipment (36) and/or diver equipment (38) in the body of water (2) below a water surface (4) while dynamically adjusting the crane arm configuration to change the position of the suspension point (16) with respect to the crane base (24) so as to at least partially compensate for the change in position and/or orientation of the crane (14) resulting from vessel motion.
